(19) United States
(12) Patent Application Publication
(10) Pub. No.: US 2025/0312973 A1
(43) Pub. Date: Oct. 9, 2025

(54) CONTINUOUS CARBON FIBER CO-EXTRUSION TOOL FOR MULTI-AXIS MATERIAL EXTRUSION

(71) Applicant: VIRGINIA TECH INTELLECTUAL PROPERTIES, INC., Blacksburg, VA (US)

(72) Inventors: Kieran D. Beaumont, Blacksburg, VA (US); Joseph R. Kubalak, State College, PA (US); Christopher Williams, Blacksburg, VA (US)

(21) Appl. No.: 19/171,885

(22) Filed: Apr. 7, 2025

Related U.S. Application Data
(60) Provisional application No. 63/631,076, filed on Apr. 8, 2024.

(51) Int. Cl. B29C 64/336; B29C 64/209; B29C 64/314; B29K 307/04; B33Y 30/00; B33Y 40/00

(52) U.S. Cl. CPC B29C 64/336; B29C 64/209; B29C 64/314; B33Y 30/00; B33Y 40/00; B29K 2307/04

(57) ABSTRACT

An exemplary three-dimensional (3D) printer deposition tool of the present disclosure comprises a filament feeder mechanism for feeding thermoplastic filament into a print head nozzle; a carbon fiber towpreg feeder mechanism for feeding carbon fiber towpreg into the print head nozzle; a carbon fiber towpreg cutting mechanism; and/or a controller configured to co-extrude continuous carbon fiber towpreg with the thermoplastic filament in a multi-axis path and cut and re-feed the carbon fiber towpreg into the print head nozzle for non-continuous toolpaths.

### CROSS-REFERENCE TO RELATED APPLICATION

This application claims priority to co-pending U.S. provisional application entitled, “Continuous Carbon Fiber Co-Extrusion Tool for Multi-Axis Material Extrusion,” having application No. 63/631,076, filed Apr. 8, 2024, which is entirely incorporated herein by reference.

### BACKGROUND

Additive Manufacturing (AM) is conventionally a layer-by-layer process where material or energy is selectively deposited to form a three-dimensional (3D) object. This advanced manufacturing technique enables the rapid manufacture of parts with high geometric complexity. Material Extrusion (MEX) is a type of AM where material (often a thermoplastic filament) is extruded along a programmed toolpath. For thermoplastic materials, the filament is fed into a heated chamber, melted, and then rapidly cools upon extrusion, allowing depositions to be stacked until the final part is constructed. Despite the geometric flexibility provided by this process, parts constructed with MEX generally suffer from poor inter- and intra-layer bonding. If fillers (e.g., fibers) are inserted into the material, this further amplifies the anisotropic behavior by improving properties along the deposition path while potentially decreasing bonding potential between layers. In addition, MEX has historically only used non-engineering thermoplastics due to the thermal cycling experienced by the polymer during construction. Because of these drawbacks, the applications of MEX have been limited to creating prototypes, models, and low-load-bearing parts. Improving the mechanical performance of parts manufactured with MEX is an active area of research. Two promising approaches are using fiber-reinforced composite materials and multi-axis printing.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 demonstrates existing techniques of continuous carbon fiber reinforcement (as originally obtained from https://www.compositesworld.com/articles/3d-printing-with-continuous-fiber-a-landscape).

FIG. 2 illustrates the creation of a traction force to help pull dry fiber through a printer nozzle from a previously cooled filament.

FIGS. 3(a)-3(b) show a side view and a front view of a minimum collision-free radii that can be printed with a multi-axis 3D printer by Backer et al, where FIGS. 3(a)-3(b) are originally obtained from W. Backer, “Multi-Axis Multi-Material Fused Filament Fabrication with Continuous Fiber Reinforcement,” Theses Diss., January 2017, available at https://scholarcommons.sc.edu/etd/4397.

FIG. 4 is an image of an approximate collision cone for a multi-axis deposition tool by Anisoprint, where the figure is originally obtained from https://anisoprint.com/solutions/desktop/(accessed Feb. 10, 2023) and is titled “Desktop Anisoprinting|Anisoprint.”

FIG. 5 is a schematiordance with various embodiments of the present disclosure.

FIG. 6 shows a computer-aided design (CAD) of an exemplary multi-axis MEX continuous carbon fiber reinforcement (CCFR) deposition tool in accordance with various embodiments of the present disclosure.

FIG. 7 shows an image of an assembled prototype of a functional multi-axis MEX CCFR deposition tool in accordance with various embodiments of the present disclosure.

FIGS. 8(a) and 8(b) depict collision cones for (a) an exemplary full multi-axis MEX CCFR deposition tool and a (b) its heatblock in accordance with various embodiments of the present disclosure.

FIG. 9 demonstrates collision-free print movement with a needle-like toolhead on a multi-axis toolpath in accordance with various embodiments of the present disclosure.

FIG. 10 illustrates potential collisions with a box-like toolhead on a multi-axis toolpath in accordance with the present disclosure.

FIG. 11 presents a section view of a fiber towpreg cutter and re-feeder, polymer feeder, and co-extrusion heatblock in accordance with various embodiments of the present disclosure.

FIG. 12 is an image of a prototype fiber towpreg cutter and re-feeder in accordance with various embodiments of the present disclosure.

FIG. 13 shows a labeled section view of an exemplary fiber towpreg cutter and re-feeder mechanism in accordance with various embodiments of the present disclosure.

FIG. 14 is an image of a prototype co-extrusion heatblock in accordance with various embodiments of the present disclosure.

FIG. 15 shows a labeled section view of an exemplary co-extrusion heatblock in accordance with various embodiments of the present disclosure.

FIG. 16 demonstrates the significance of fiber-polymer interaction time with respect to preventing clogging and minimizing fiber breakage in accordance with the present disclosure.

FIGS. 17(a)-(c) are images of a process for multi-axis MEX CCFR printing of a (a) cylinder, (b) rectangle tensile bar, and (c) multi-axis part in accordance with the present disclosure.

FIGS. 18(a)-(c) are images of the final resulting MEX CCFR print builds of the (a) cylinder, (b) rectangle tensile bar, and (c) multi-axis part of FIG. 17(a)-17(c).

FIG. 19 shows tensile test results for printed continuous carbon fiber polylactic acid (CCF-PLA), short carbon fiber PLA (SCF-PLA), and neat PLA tensile bars.

FIGS. 20(a)-(c) demonstrate nozzle designs having a straight turn, a rounded turn, or a changing orientation when extruding fiber materials in accordance with various embodiments of the present disclosure.

FIGS. 21(a)-(c) show section views of alternative heatblock designs in accordance with various embodiments of the present disclosure.

FIGS. 22(a)-(b) illustrate the phenomena of feeding a fiber (a) too slow or (b) too fast within an extrusion nozzle in accordance with the present disclosure.

FIG. 23 is a block diagram of a three-dimensional printer system in accordance with an embodiment of the present disclosure.

### DETAILED DESCRIPTION

The present disclosure pertains to a continuous fiber deposition tool for use with multi-axis material extrusion (MEX) additive manufacturing (AM). Such a tool and related methods/systems enable the co-extrusion and cutting of continuous fiber in full 3D. Embodiments of systems and methods of the present disclosure are configured to co-extrude continuous carbon fiber towpreg with thermoplastic materials; cut fiber and restart deposition automatically; and deposit material along paths that break outside of the XY-plane. In accordance with various embodiments, a multi-axis MEX-AM tool of the present disclosure is mounted to a 6-degree-of-freedom robot arm for enabling reorientation of the tool relative to the part being manufactured, while providing a small collision volume to provide as much flexibility as possible when executing multi-axis toolpaths. This capability offers additional opportunities, especially relative to traditional methods for manufacturing carbon fiber composite structures (e.g., wet layup, pultrusion, prepreg layup, etc.), which are unable to create small, intricate geometries where the fibers are aligned in the optimal direction.

As such, an exemplary multi-axis continuous carbon fiber reinforcement (CCFR) MEX-AM tool of the present disclosure is designed for material extrusion (MEX) additive manufacturing of continuous carbon fiber reinforced thermoplastics in that the tool has the ability to cut and restart fiber placement for non-continuous toolpaths and has a narrow collision volume to enable material deposition along expected stress paths that break outside of the XY-plane (i.e., multi-axis).

Most existing MEX composites use short-fibers to ease the printing process, but this greatly limits the fiber's potential for improving mechanical performance. Recently, printing with continuous fibers has been explored, but the existing tools either lack a fiber cutting mechanism (making travel movements impossible) or have a box-like collision volume (limiting the potential for multi-axis deposition).

Applications of material extrusion (MEX) have historically been limited to prototypes, models, and low-load bearing parts due to poor inter-and intra-layer bonding and an inability to process high-strength materials. Multi-axis deposition of filament with continuous carbon fiber can overcome both of these limitations by providing increased mechanical properties along the expected 3D stress paths in the end-use part. The present disclosure presents a new tool design capable of both multi-axis deposition and continuous carbon fiber reinforcement to create high-performance MEX parts. The tool can cut and restart fiber deposition, control fiber-volume fraction, and print concave multi-axis toolpaths. The capabilities of this tool have been demonstrated through the successful printing of both XY-planar and multi-axis toolpaths. An ultimate tensile strength of 193.6 MPa was achieved with 1.5 k carbon fiber towpreg and polylactic acid (PLA) as the matrix.

One of the most common forms of fiber-reinforcement in MEX is a thermoplastic material filled with short carbon fibers (SCF). This technique is widely used because it can be printed with a traditional MEX deposition tool. Ning et al. found that acrylonitrile butadiene (ABS) showed a 23.5% increase in tensile strength and a 30.5% increase in young's modulus and when reinforced with 7.5 wt % SCF. Despite this improvement, SCF does not take full advantage of the potential benefits that carbon fiber reinforcement can provide. Fiber length has been seen to have a large impact on mechanical properties, and thus by chopping or milling continuous fiber into small segments, much of the original strength is lost.

Although MEX of short/chopped carbon fibers achieves slight improvements in mechanical properties, its full potential is not realized by chopping the fiber into small segments. MEX of continuous carbon fiber has been successfully demonstrated for traditional XY-printing but all current solutions for multi-axis fiber printing lack at least one of the following: (a) Cutting and refeeding of fiber for non-continuous deposition paths; (b) Tool collision volume well suited for multi-axis toolpaths; and (c) Live control of filament/fiber ratio. Despite these shortcomings, MEX of thermoplastics with continuous carbon fiber (CCF) has shown the potential to increase tensile strength by over 1500%, but it is a much more challenging process than SCF and requires a specialized deposition tool. The five most recognized methods for continuous carbon fiber reinforcement are shown in FIG. 1. However, these images all lack an important design component for a CCF tool: a mechanism to cut the continuous fiber. In traditional MEX, when the tool stops extruding in one location and quickly travels to another, the filament inside the extruder shears from the filament already deposited. When printing with CCF (or other continuous reinforcement), this movement does not create enough force to shear the fiber and will instead rip the part off the bed or pull additional fiber through the nozzle. If a CCF tool does not have a fiber cutting mechanism, only a continuous deposition path can be printed which greatly limits the potential geometries that can be manufactured. With respect to FIG. 1, the figure is originally obtained from and credited to “3D printing with continuous fiber: A landscape,” Jul. 13, 2022, https://www.compositesworld.com/articles/3d-printing-with-continuous-fiber-a-landscape (accessed Feb. 10, 2023).

The three most common forms of CCF-MEX of thermoplastics both commercially and in literature are in-situ impregnation, towpreg extrusion, and co-extrusion with towpreg. In-situ impregnation is a process where dry carbon fiber tow and a thermoplastic material are joined in the nozzle and extruded together. In 2016, Matsuzaki et al. developed a tool capable of co-extruding dry fiber tow with polylactic acid (PLA) and observed a tensile strength of 185.2 MPa, 435% greater than their neat PLA sample. In 2022, Zhang et al. observed a tensile strength of 610 MPa with their CCF-PLA sample which is almost 15 times what others have seen for a neat PLA. Despite the clear mechanical advantage of using CCF in MEX, Matsuzaki et al. noted that the in-situ impregnation process resulted in poor bonding between the carbon fiber tow and the PLA matrix as well as high void formation. This poor bonding and void formation could potentially introduce weaknesses between roads and layers.

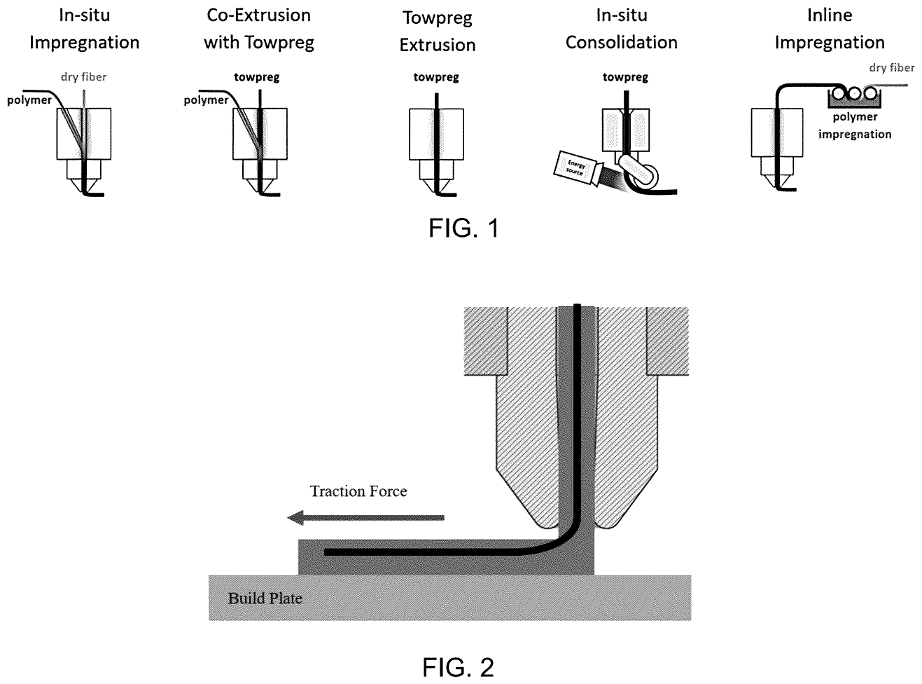

Another drawback of in-situ impregnation is that the dry fiber is highly flexible. For traditional MEX, the polymer filament is stiff, which enables a set of feeding wheels to push the filament into the hotend where it melts and is then extruded out of the nozzle. The same cannot be done with dry fiber because it will buckle under any form of resistance. Attempts thus far for in-situ impregnation have relied on a traction force provided by previously deposited material to pull the fiber through the nozzle, as demonstrated in FIG. 2. However, this greatly complicates the process of cutting the fiber for non-continuous printing operations. Once the fiber is cut, the traction force is gone, and the extrusion cannot be reinitiated easily.

To overcome the need for traction force, carbon fiber tow can be pre-impregnated in a controlled environment before entering the tool. This process creates a towpreg with a much greater stiffness that can be pushed through the nozzle like a traditional polymer filament. Towpreg can either be extruded by itself (towpreg extrusion) or co-extruded with additional polymer (co-extrusion with towpreg). In 2015, Markforged released a printer called the Mark One which utilized towpreg extrusion and was capable of reliably cutting and re-feeding fiber. Klift et al. performed a study on the Mark One and found an average tensile strength of 464.4 MPa for a 6CF towpreg. Although towpreg extrusion is a promising method for CCF-MEX, experimenting with different polymer-fiber combinations and ratios can be more time consuming. Additionally, not having live control over these parameters means that it would be harder to functionally grade properties throughout a part.

Co-extrusion with towpreg can be thought of as a hybrid of in-situ impregnation and towpreg extrusion. In this process, a towpreg is combined with additional polymeric material inside the tool and extruded together. In 2017, Backer pre-impregnated a spool of carbon fiber tow with ULTEM 1000 to create a stiff composite. Then, they co-extruded this composite with additional ULTEM during the printing process giving them live-control over the polymer-fiber ratio. With a fiber volume fraction of 17.4% they achieved a tensile strength of 623.3MPa. However, despite using a stiff towpreg, Backer was unable to design a reliable cutting and re-feeding mechanism, achieving a success rate of 87% over 14 trials. Zhang et al. and Maqsood et al. also used the co-extrusion with towpreg process, but neither demonstrated cutting the fiber for non-continuous deposition paths. In 2020, Anisoprint released the Composer which is a commercial desktop machine capable of co-extruding a range of thermoplastics with pre-impregnated carbon fiber. With this desktop printer, they not only have the capability to adjust filament-fiber ratios, but also figured out a method of cutting and re-feeding their towpreg reliably. Markforged and Anisoprint's successes have indicated that both towpreg extrusion and co-extrusion with towpreg have the potential to be used for printing complex geometries that require non-continuous deposition paths.

Multi-axis MEX is a process where the deposition tool is reoriented relative to the part and can deposit material along paths that break out of the XY-plane. This process can be used to locally control the anisotropy throughout a part to achieve greater mechanical properties in a specific load case. Although the exact improvement is highly dependent on both the geometry and tool-pathing strategy, Kubalak noted a 108.24% increase in tensile strength when comparing the multi-axially constructed part to the same part sliced in the XY-plane. To accomplish multi-axis printing, there are several hardware considerations for both the deposition tool and the kinematic platform. Kubalak uses a 6-degree-of-freedom industrial robot arm instead of a traditional 3-axis gantry and Fang et al. has demonstrated the ability to print directly onto a tilt-turn table. Kubalak also mentions the importance of minimizing the tool's collision volume to improve accessibility. To quantify a tool's collision volume, Kubalak used a cone, centered at the tip of the nozzle, with an angle defined by the outermost point of the tool.

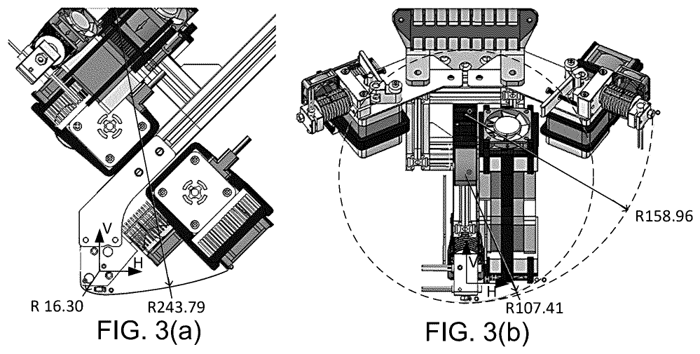

Continuous fiber reinforcement can greatly improve the strength of a part along the direction of deposition. By combining this technology with multi-axis printing strategies, the benefits of continuous carbon fiber reinforcement can be seen for more complex parts with 3D load cases. Backer, who after experimenting on a traditional gantry, transitioned their tool to the end of an industrial robotic arm to demonstrate a number of multi-axis deposition paths. Like Kubalak, Backer also mentioned the importance of minimizing collision volume for multi-axis printing and provided FIGS. 3(a)-3(b) to describe the minimum collision-free concave curvature that could be printed with the tool. Despite this, their tool is still greatly limiting its potential for concave deposition paths, and it does not feature a fiber cutting mechanism. With respect to FIGS. 3(a)-3(b), the figures are originally obtained from and credited to W. Backer, “Multi-Axis Multi-Material Fused Filament Fabrication with Continuous Fiber Reinforcement,” Theses Diss., January 2017, at https://scholarcommons.sc.edu/etd/4397.

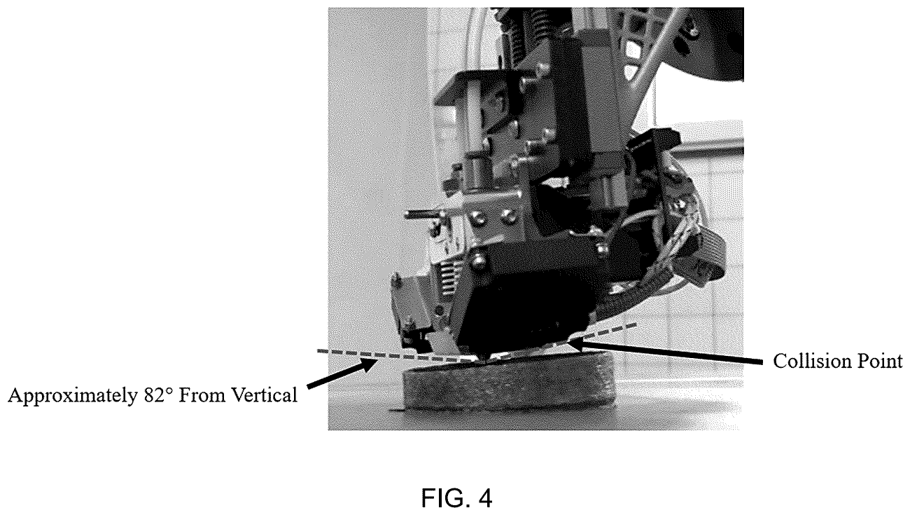

In 2022, Anisoprint published a website article stating that they had attached a CCF deposition tool to the end of a robot arm and demonstrated some simple multi-axis toolpaths. However, they appeared to have made no changes regarding collision volume. In FIG. 4, an approximate measurement has been taken from an image on Anisoprint's website. The outermost point of their tool occurs at a cone angle of approximately 82 degrees due to the part cooling fans which limits their ability to print concave curves. With respect to FIG. 4, the figure is originally obtained from and credited to https://anisoprint.com/solutions/desktop/(accessed Feb. 10, 2023) and is titled “Desktop Anisoprinting|Anisoprint.”

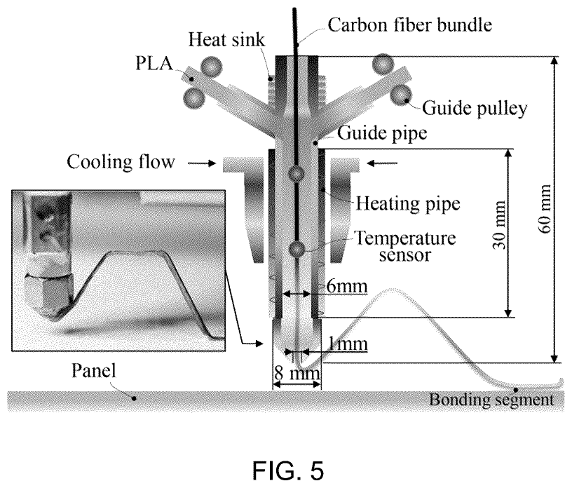

In 2017, Liu et al published a CCF tool design capable of printing 3D lattice truss structures, as shown in FIG. 5. Due to what they call a “slender” nozzle design, they can print trusses that extend out of the XY plane without collisions. To test the CCF's effectiveness, they performed a compressive test on a lattice truss core sandwich and observed a 224% higher compressive strength in the truss when it was printed with CCF. Theoretically, this tool could be used for non-truss geometries, but it does not feature a fiber cutting mechanism. Additionally, because it was mounted to a 3-axis gantry with no orientation control, certain multi-axis paths would be impossible (e.g., printing off the side of a cube). With respect to FIG. 5, the figure is originally obtained from and credited to S. Liu, Y. Li, and N. Li, “A novel free-hanging 3D printing method for continuous carbon fiber reinforced thermoplastic lattice truss core structures,” Mater. Des., vol. 137, pp. 235-244, January 2018, doi: 10.1016/j.matdes.2017.10.007.

Ideally, a CCF multi-axis deposition tool would have a collision cone angle of 0 degrees, like a long, slender needle. However, there are several practical design constraints that make this challenging: (i) The heatblock must have enough thermal mass to maintain a consistent temperature; (ii) a fiber cutting mechanism must be placed close to the nozzle to enable short deposition paths; and (iii) fans, or other forms of cooling, must be attached to prevent heat creeping up through the tool. Because traditional XY-printing does not need to consider the same collision volume constraints, these design challenges are rather new in the MEX field and commercial solutions are limited.

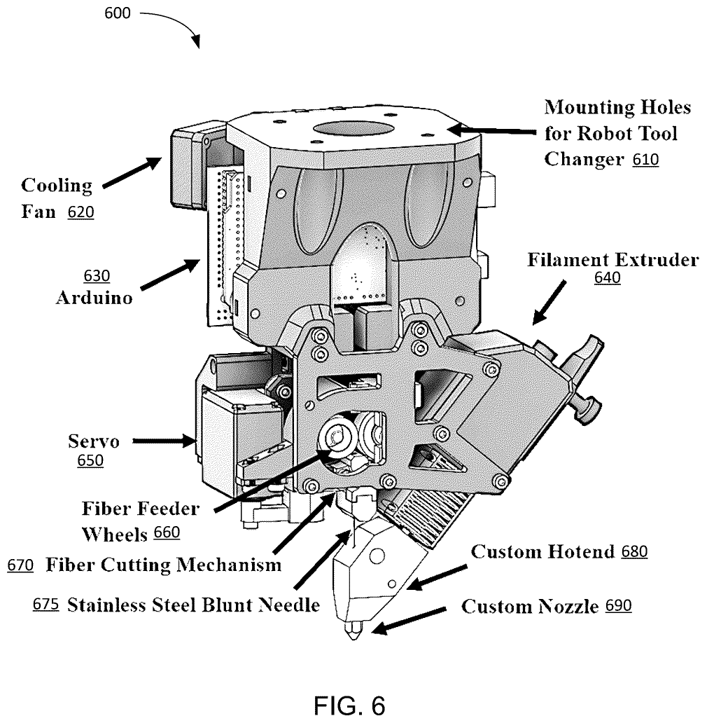

In accordance with various embodiments of the present disclosure, a deposition tool is provided for multi-axis MEX of CCF reinforced composites, as shown in FIG. 6. Here, the deposition tool 600 includes a mount 610 with mounting holes for coupling to a robot arm, a cooling fan 620, a controller 630 (e.g., Arduino processor circuit board); a filament extruder 640 for feeding building supply material (e.g., ink filament material), a servo motor 650 and fiber feeder wheels 660 for activating the fiber cutting mechanism 670, a needle for guiding carbon fiber filament 675, and a hotend 680 and nozzle 690 for the print head.

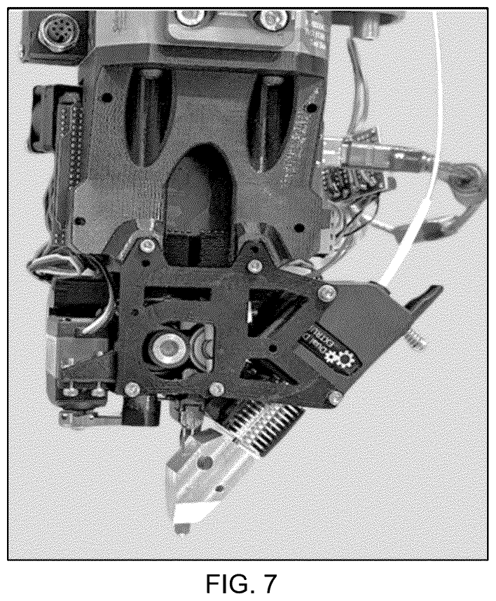

In various embodiments, an exemplary deposition tool co-extrudes carbon fiber towpreg with thermoplastic filament and can cut and re-feed the towpreg for non-continuous toolpaths. Such a tool has a smaller collision volume than traditional MEX deposition tools giving it a greater ability to print more complex (e.g., concave) multi-axis toolpaths. In various embodiments, select components are commercially sourced and can be swapped for equivalent parts with no impact on the design's functionality, such as a Bondtech Dual Drive Extruder, E3D HeatSink, E3D HeatBreak, Cooling Fans, High-Torque Servo, and Arduino MEGA 2560 with RAMPS v1.4 Shield. A fully constructed and operational prototype of an exemplary multi-axis CCFR MEX-AM tool is shown in FIG. 7.

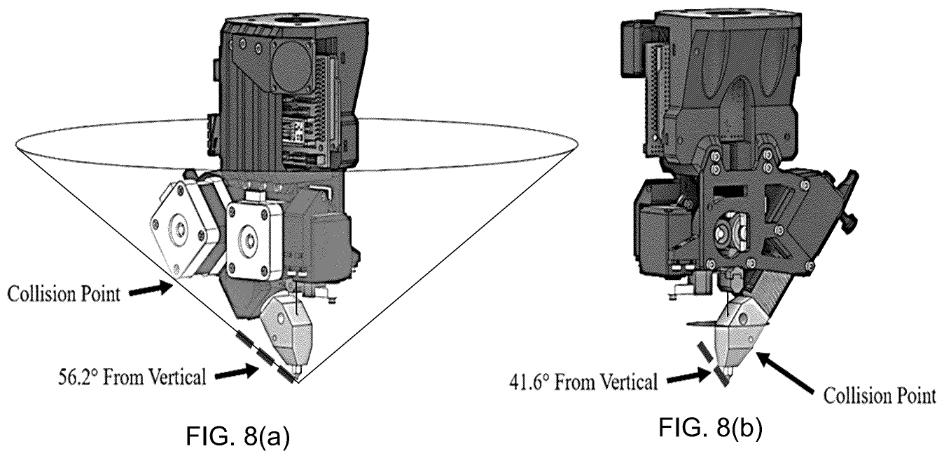

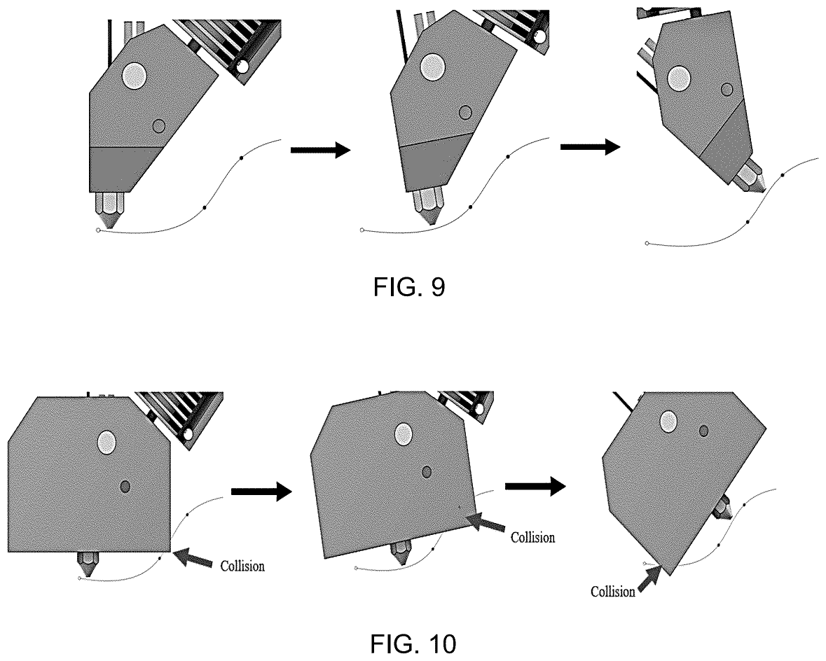

One of the features of this design is its needle-like collision volume. For the full tool assembly, there is a minimum cone angle of 56.2 degrees before a collision occurs with one of the stepper motors, as demonstrated in FIG. 8(a). For printing smaller features, or with intelligent, collision-avoidance tool-pathing, an angle of 41.6 degreescould be achieved, as illustrated in FIG. 8(b). This shows a significant improvement over both Backer and Anisoprint's multi-axis CCF tools. Correspondingly, FIG. 9 shows the current design navigating a curved toolpath without collisions and FIG. 10 shows a comparable box-like tool attempting to print the same curve with frequent collisions.

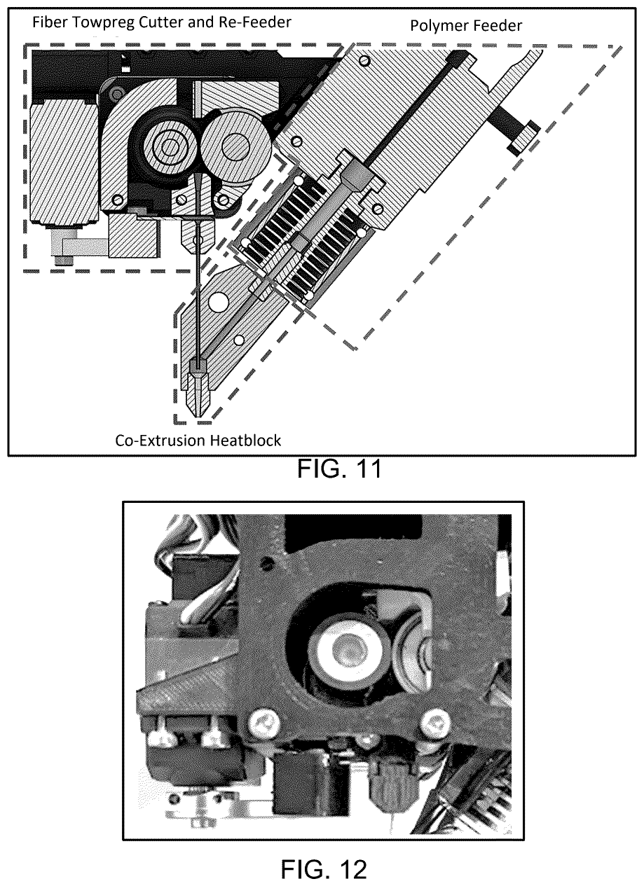

A second feature of this design is the mechanism that cuts, re-feeds, and co-extrudes the towpreg with additional polymer. FIG. 11 shows a section view of these features. Many existing multi-axis CCF tools, including Backer's and Liu's, lack a cutting mechanism. Cutting and re-feeding fiber is a challenging process that requires many distances and tolerances to be fine-tuned to ensure a clean cut and prevent fiber buckling or breakage. Additionally, any CCF process that does actively feed stiff towpreg will have great difficulty re-initiating the traction force once the fiber is cut. To overcome the challenges of cutting and re-feeding, the following design considerations were implemented: (i) minimized fiber feeding tube diameter, (ii) minimized fiber cutting blade gap, and (iii) a needle was used to introduce the fiber into an already downward-flowing polymer.

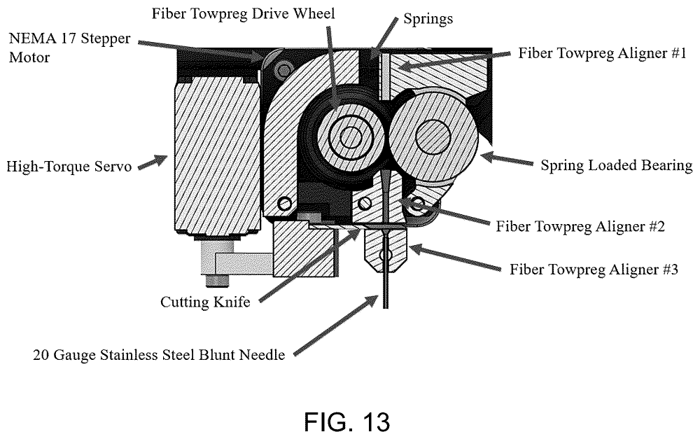

The towpreg cutter and re-feeder mechanism, shown in FIG. 12 and labeled in FIG. 13, starts by aligning the towpreg directly above the drive wheel and bearing. These wheels then grip the towpreg and push it into another alignment piece. The bearing has an adjustable spring tensioner to accommodate different sizes of towpreg and to ensure a firm, constant pressure is applied. The second alignment piece holds the towpreg in position during cutting. When ready to cut, the servo rotates quickly and uses the blade to cleanly shear the fiber. The gap that the blade slides through is as small as possible to ensure a clean cut. The towpreg then enters the third alignment piece where it is funneled into the stainless-steel needle. This alignment piece has chamfered edges to ensure the slightly frayed edge of the cut fiber is straightened.

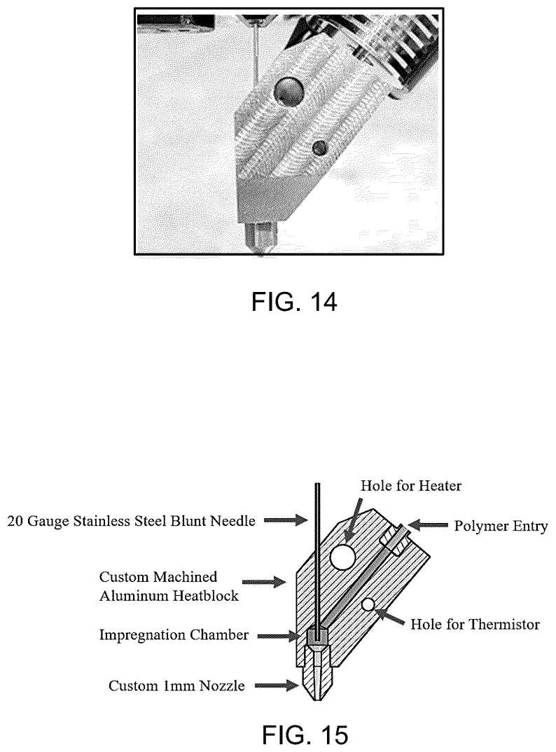

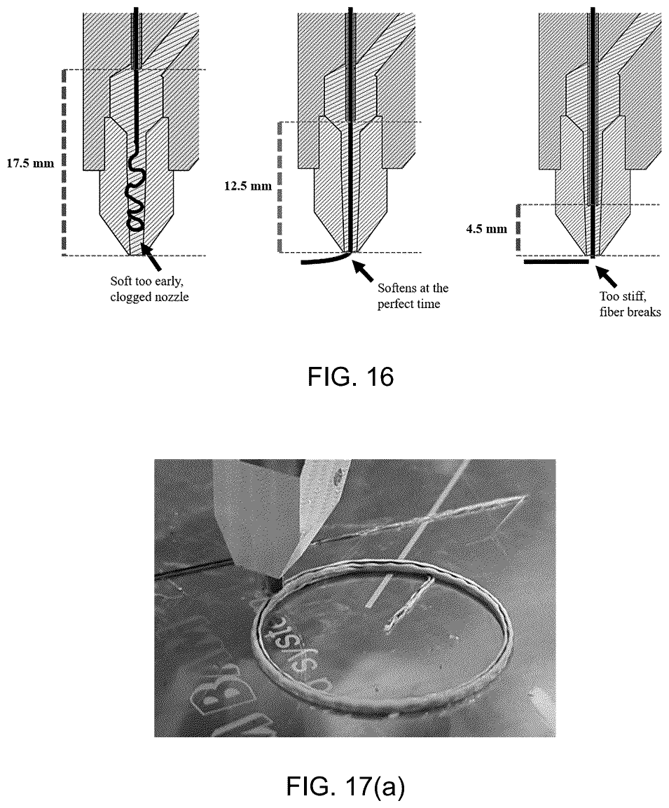

As the towpreg is fed through the needle, it enters the co-extrusion heatblock, as shown in FIG. 14 and labeled in FIG. 15. The needle both preheats the towpreg ready to be bonded to the thermoplastic filament and serves as a thermal insulator to connect the heat block with the plastic alignment piece. Once the towpreg has been fed through the needle, it enters the center of the polymer melt pool. Inside this melt pool is where the stiff fiber towpreg finishes softening and bonds with the polymer filament. The amount of time the fiber interacts with the polymer filament is important to prevent clogging and minimize fiber breakage. As shown in FIG. 16, if the towpreg spends too much time inside the melt pool it will become flexible too early and clog the nozzle. If the towpreg does not spend enough time softening in the melt pool, the fiber will still be stiff and break upon exiting the nozzle. With this design, both print speed and needle length can be modified easily to experiment with fiber-polymer interaction time.

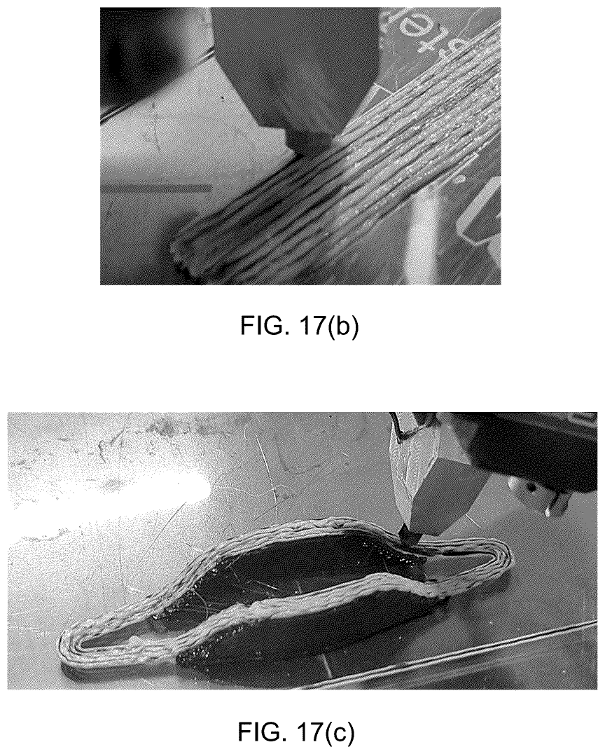

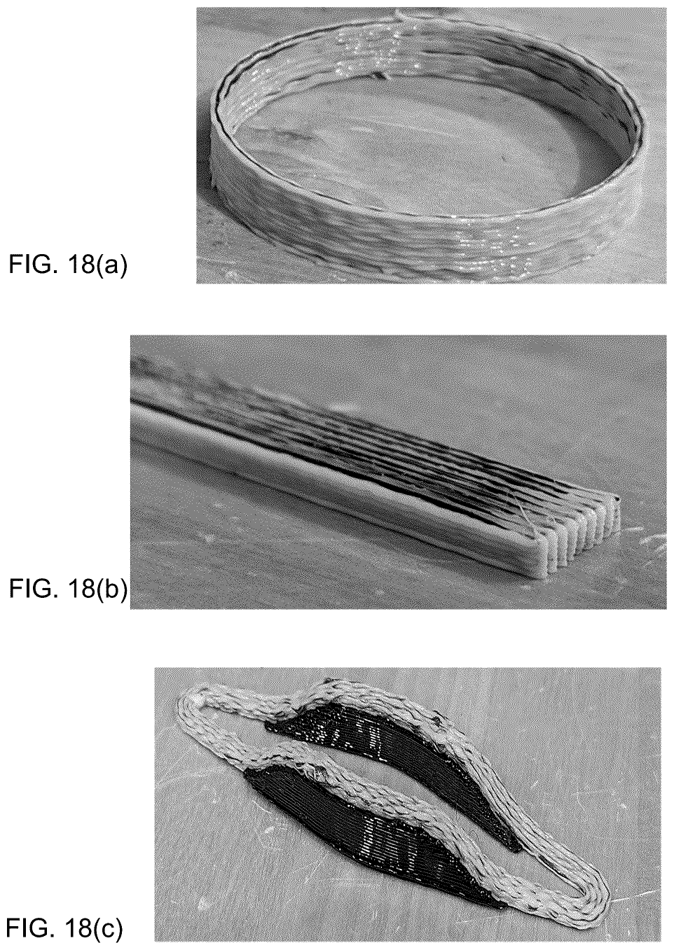

In efforts to demonstrate its effectiveness, an assembled (CCFR) MEX-AM tool has been used to successfully print two XY planar geometries (cylinder and rectangular tensile bar) and one multi-axis geometry. The printing process is illustrated in FIGS. 17(a)-(c) and the final parts can be seen in FIGS. 18(a)-18(c) for a printing cylinder, rectangle tensile bar, and a multi-axis part.

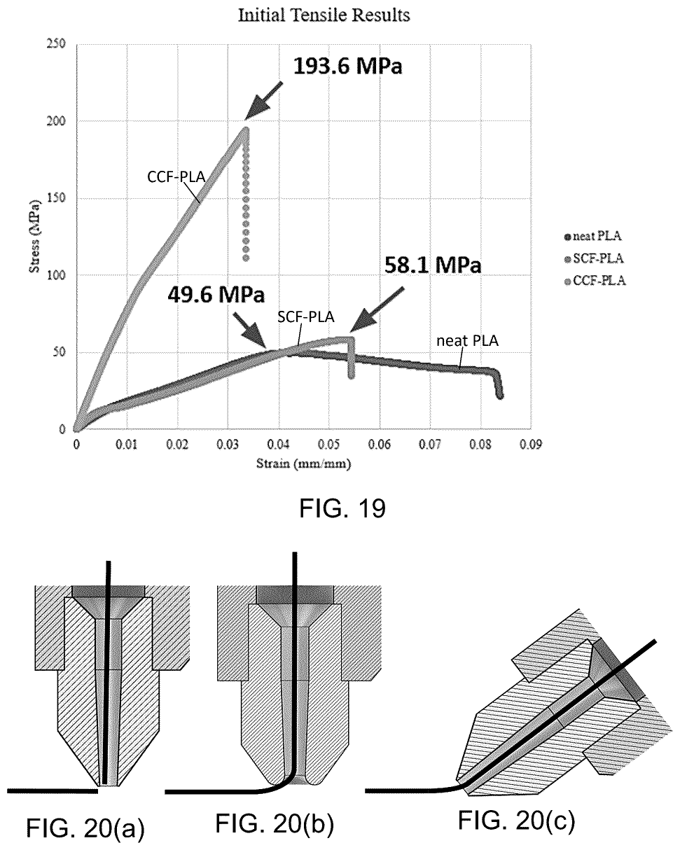

To ensure the continuous fiber was providing reinforcement to the final part, neat PLA, SCF-PLA, and CCF-PLA tensile bars were printed. The results of each tensile test, performed at 2 mm/min, are shown in FIG. 19. The CCF-PLA, SCF-PLA, and neat PLA samples achieved ultimate tensile strengths of 193.6 MPa, 58.1 MPa, and 49.6 MPa respectively. It can be seen from this data that the introduction of continuous carbon fiber was able to more than triple the achievable tensile strength of neat PLA and SCF-PLA.

In various embodiments, additional features may be deployed. For example, while certain embodiments may feature a sharp 90 degree turn that the fiber makes when exiting the nozzle, as depicted in FIG. 20(a), other embodiments may feature a design that (i) rounds the inside edge of the nozzle, as shown in FIG. 20(b), and/or (ii) uses the robot's ability to control tool orientation to extrude the fiber at a shallower angle, as shown in FIG. 20(c).

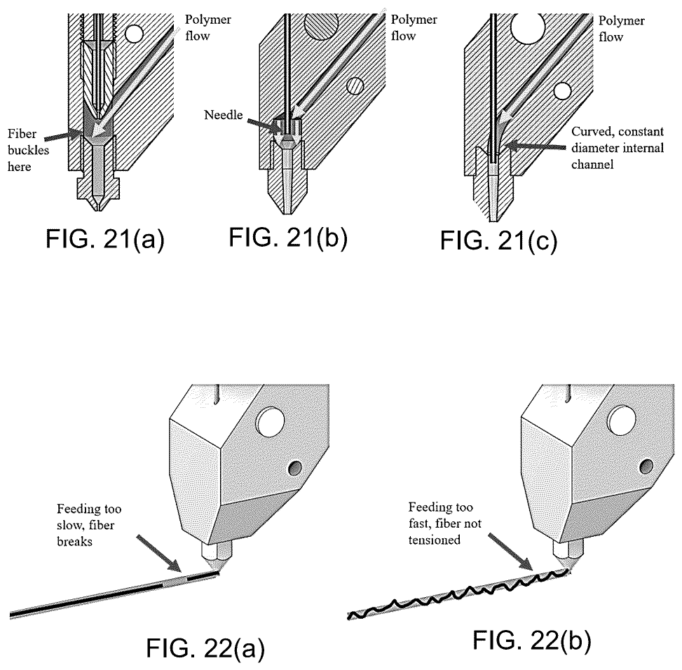

Also, various embodiments may utilize differing internal geometry of the heatblock, which can improve or affect fluid flow and fiber alignment. For example, FIG. 21(a) shows one possible heatblock design where polymer flow may cause a fiber to buckle and break, where FIG. 21(b) shows an alternative heatblock design utilizing a steel needle to prevent buckling of the fiber from the polymer flow and the polymer flow pushing the fiber from one side by introducing the fiber lower down in the melt pool when the polymer is already moving directly downwards. Correspondingly, FIG. 21(c) shows an alternative heatblock design having a curved, constant diameter internal channel, that may provide a better fluid flow. Such a design can be printed out of metal using a process like Powder Bed Fusion (PBF), in various embodiments.

Lastly, although actively feeding the fiber enables cuts and travel movements, it adds an extra complication where the speed of the fiber must exactly match the speed of the tool. If the feeding speed is too fast, the fiber will not be properly tensioned in the part. If the feeding speed is too slow, either the fiber will get pulled out of the part or the fiber will break on the nozzle. An illustration of this phenomena can be seen in FIGS. 22(a)-(b). One potential way to solve this issue is to read the instantaneous speed of the robot either through an externally guided motion package or with an analog output module. This signal can then be sent directly to the extruder to perfectly match the speed, including accelerations and decelerations. Another option is to design feeder wheels that can be disengaged. These feeder wheels would only be used to re-feed the fiber after it is cut and extrude the first few millimeters of the print movement. Once this small section cools, the wheels can disengage, and the robot can continue. The tension force created by the cooled filament will passively pull the fiber through the nozzle at the exact speed of the tool.

Co-extruding continuous carbon fiber with thermoplastic filament greatly increases a printed part's stiffness and strength in the direction of the deposition path, such that robotic multi-axis tool-pathing is capable of aligning those deposition paths in 3D (i.e., breaking out of the XY plane). The described tool of the present disclosure is capable of both continuous carbon fiber reinforcement and multi-axis deposition which can overcome the described existing limitations of material extrusion and open up the technology's application space to higher load-bearing, functional parts.

Benefits of the present disclosure include the following: Continuous strands of carbon fiber are strong in tension along the length of the fiber, and thus are well suited to being embedded in the deposition paths created by the MEX process; Thermoplastic material acts as a matrix to hold the carbon fibers in the optimal orientation; Multi-axis deposition of carbon fiber enables optimal reinforcement for parts with 3D load cases; Cutting and refeeding fiber enables printing parts that require travel (non-extrusion) movements; Carbon fiber has a high strength to weight ratio and can greatly increase the mechanical performance of MEX parts.

Continuous carbon fiber reinforcement in multi-axis material extrusion enables full control of fiber placement in 3D to create complex geometries with high strength and stiffness and low material waste, weight, and part count. This tool could be used for ground, air, and water-based vehicles, or any other application that could benefit from a high strength-to-weight ratio (e.g., aerospace and automotive industries).

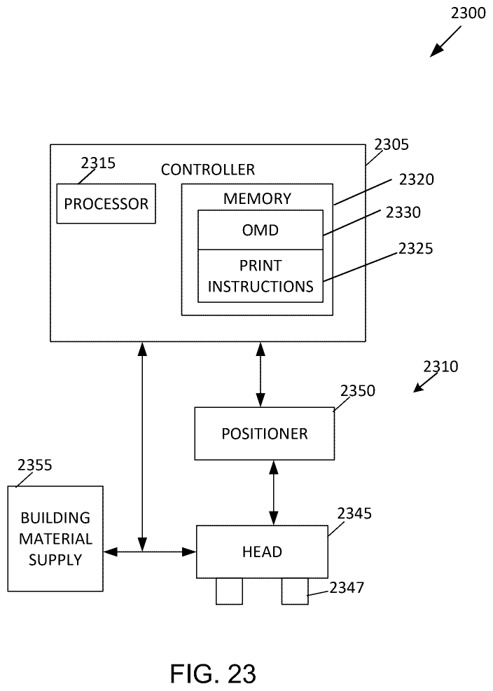

Referring now to FIG. 23, a block diagram of a 3D printer system 2300 in accordance with an embodiment of the present disclosure is shown. The 3D printer system 2300 includes a controller 2305 and a printing apparatus 2310. Controller 2305 is configured to prepare digital data that characterizes a 3D object for printing, and control the operation of the printing apparatus 2310. The controller 2305 may include, for example, a processor 2315, a memory unit 2320, and print instructions or firmware 2325.

Data and instructions maybe transferred between controller 2305 and a CAD (computer-aided design) module (not shown), between controller 2305 and printing apparatus 2310, and/or between controller 2305 and other system elements, such as a multi-axis motor controller, cooling system, etc. Accordingly, controller 2305 may be suitably coupled and/or connected to various components of printing apparatus 2310.

Controller 2305 may utilize object modeling data (OMD) 2330 representing an object to be printed. Controller 2305 may convert such data to instructions for the various units within 3D printer system 2300 to print a 3D object. Controller 2305 may be located inside printing apparatus 2310 or outside of printing apparatus 2310. Controller 2305 may be located outside of printing system 2300 and may communicate with printing system 2300, for example, over a wire and/or using wireless communications. In some embodiments, controller 2305 may include a CAD module/system or other suitable design system. In alternate embodiments, controller 2305 may be partially external to 3D printer system 2300. For example, an external control or processing unit (e.g., a personal computer, workstation, computing platform, or other processing device) may provide some or all of the printing system control capability.

In some embodiments, print instructions 2325, a print file, or other collection of print data may be prepared and/or provided and/or programmed, for example, by the controller 2305 or a computing platform connected to 3D printer system 2300. The print instructions 2325 may be used to determine, for example, the order and configuration of deposition of building material via, for example, movement of and activation and/or non-activation of one or more print nozzles 2347 of print head 2345, according to the 3D object to be built. In accordance with the present disclosure, the print instructions 2325 may further be configured to determine a spatial path of a print nozzle 2347. According to some embodiments, the print nozzle 2347 may include a fine hollow tip, which may carefully trace out spatial paths while extruding building material supplies 2355, such as co-extruding continuous carbon fiber towpreg material with the thermoplastic filament in a multi-axis path. In one embodiment, the print instructions comprise, but are not limited to, G-code toolpath instructions for the controller.

Printing apparatus 110 may include positioner assembly 2350. Positioner assembly 2350 may control the movement of print head 2345, such as by multiple linear stages controlled by stepper motors. Likewise, extruder(s) may control the flow of ink materials to and through the print nozzle 2347, such as by a stepper motor. Additionally, the positioner assembly and/or print nozzle assembly may include a fiber cutting mechanism for cutting and re-feeding carbon fiber towpreg material for non-continuous toolpaths.

Controller 2305 may be implemented using any suitable combination of hardware and/or software. In some embodiments, controller 2305 may include, for example, the processor 2315, the memory unit 2320, and software or operating instructions, such as print instructions 2325. Processor 2315 may include conventional devices, such as a Central Processing Unit (CPU), a microprocessor, a “computer on a chip”, a micro controller, etc. Memory unit 120 may include conventional devices such as Random Access Memory (RAM), Read-Only Memory (ROM), or other storage devices, and may include mass storage, such as a CD-ROM, SD/Micro SD, USB storage devices, or a hard disk. Controller 2305 may be included within, or may include, a computing device such as a personal computer, a desktop computer, a mobile computer, a laptop computer, a server computer, or workstation (and thus part or all of the functionality of controller 2305 may be external to 3D printer system 2300). Controller 2305 may be of other configurations, and may include other suitable components.

It should be emphasized that the above-described embodiments of the present disclosure are merely possible examples of implementations, merely set forth for a clear understanding of the principles of the disclosure. Many variations and modifications may be made to the above-described embodiments without departing substantially from the spirit and principles of the disclosure. All such modifications and variations are intended to be included herein within the scope of this disclosure and the following claims.

1. A three-dimensional (3D) printer deposition tool comprising:
a filament feeder mechanism for feeding thermoplastic filament into a print head nozzle,
a carbon fiber towpreg feeder mechanism for feeding carbon fiber towpreg into the print head nozzle;
a carbon fiber towpreg cutting mechanism; and
a controller configured to co-extrude continuous carbon fiber towpreg with the thermoplastic filament in a multi-axis path and cut and re-feed the carbon fiber towpreg into the print head nozzle for non-continuous toolpaths.

2. The 3D printer deposition tool of claim 1, further comprising:
a servo motor and fiber feeder wheels for activating the carbon fiber towpreg cutting mechanism.

3. The 3D printer deposition tool of claim 1, further comprising:
a mount with mounting holes for coupling the 3D printer tool to a 6-degree-of-freedom robot arm robot arm.

4. The 3D printer deposition tool of claim 1, wherein the carbon fiber towpreg feeder mechanism utilizes a needle for guiding the carbon fiber towpreg into the print head nozzle.

5. The 3D printer deposition tool of claim 1, further comprising a print head, wherein the print head comprises the print head nozzle and a heatblock element.

6. The 3D printer deposition tool of claim 5, wherein the heatblock element has a curved, constant diameter internal channel.
